(19) United States
(12) Patent Application Publication
(10) Pub. No.: US 2008/0054520 A1
(43) Pub. Date: Mar. 6, 2008

(54) Gear

(75) Inventor: Koji Tomoda, Aichi (JP)

Correspondence Address: OLIFF & BERRIDGE, PLC, P.O. BOX 320850, ALEXANDRIA, VA, 22320-4850, US

(73) Assignees: Koji Tomoda, Nagoya-shi, AICHI (JP); Yamasei Kogyo Co., Ltd., Nagoya-shi, AICHI (JP)

(21) Appl. No.: 11/662,268

(22) PCT Filed: Aug. 4, 2005
(86) PCT No.: PCT/JP05/14713

§ 371 Date: Apr. 25, 2007

(30) Foreign Application Priority Data
Sep. 9, 2004 (JP) 2004-261728

(51) Int. Cl. F16H 55/06; C08J 5/00

(52) U.S. Cl. 264/239

(57) ABSTRACT

To provide a gear which hardly peels off on a joined boundary face even where a polyamide resin-molded gear core is joined to a polyamide resin-molded gear tooth, and is excellent in dimensional accuracy. In the gear, the polyamide resin-molded gear tooth 12 is joined in an integrated form on the outer circumference of the gear core 11 having at least the circumferential part molded with a polyamide resin after a joining auxiliary agent including phenol compounds as (A) ingredients and organic solvents as (B) ingredients capable of dissolving or dispersing (A) ingredients is coated on the outer circumference of the gear core 11 or on the inner circumference of the gear tooth 12.

### TECHNICAL FIELD

The present invention relates to a gear and, more particularly, relates to a polyamide resin-made gear.

### BACKGROUND ART

Gears are known as mechanical components for conveying motion. Metals have been often used as materials for gears. Metal-made gears are manufactured by cutting work and therefore higher in dimensional accuracy but disadvantageous in producing noise, heavy in weight or high in manufacturing cost.

Therefore, in recent years, synthetic resin-made gears have been used frequently for reducing noise, making the weight lighter and attaining a lower manufacturing cost.

For example, Japanese Utility Model Public Disclosure No. Hei2-119552 has disclosed a gear in which a synthetic resin is injected on the outer circumference of an inner bush and then cutting process is conducted to make a gear tooth. Further, Japanese Patent Public Disclosure No. 2002-146068 has disclosed a gear in which a polyamide resin is molded by injection molding.

In addition, Japanese Utility Model Public Disclosure No. Hei3-29751 has disclosed a gear in which elastomer-molded gear tooth is joined in an integrate form on the outer circumference of an inner circumferential part molded with a highly rigid synthetic resin.

Furthermore, Japanese Patent Public Disclosure No. Hei6-294459 has disclosed a gear in which a disk part is molded by injecting molding of a polyamide resin, then the polyamide resin to which a carbon fiber is added is used to provide a gear tooth on the outer circumference of the disk part by injection molding, thereby fitting the gear tooth at the outside of the disk part.

However, the gears disclosed in Japanese Utility Model Public Disclosure No. Hei2-119552 and Japanese Patent Public Disclosure No. 2002-146068 are molded by a one-time injection molding, greater in transformation on cooling and solidification and difficult in obtaining a high dimensional accuracy, which is a problem to be solved. This problem becomes more apparent when gears are larger in size.

In contrast, since the gears disclosed in Japanese Utility Model Public Disclosure No. Hei3-29751 and Japanese Patent Public Disclosure No. Hei6-294459 are molded by a two-time injection molding, it is possible to make small the transformation on cooling and solidification to the most possible extent. Therefore, these gears are higher in dimensional accuracy than those molded by the one-time injection molding.

However, since the gear disclosed in Japanese Utility Model Public Disclosure No. Hei3-29751 is that manufactured by fusing together synthetic resins utterly different in characters, it is not possible to attain a high joining strength. Thus, the gear has a problem that it may easily peel off on the joined boundary face when a greater rotational torque is given.

In addition, the gear disclosed in Japanese Patent Public Disclosure No. Hei6-294459 is different from that disclosed in Japanese Utility Model Public Disclosure No. Hei3-29751 in that similar synthetic resins are fused together. Polyamide resins are in general narrow in melting-point range and very short in curing time. Therefore, only a simple joining of a polyamide resin with another polyamide resin will not provide a high joining strength and still poses a problem of easily peeling off on the joined boundary face.

The present invention has been made, with the above problems taken into account, and an object of the invention is to provide a gear which hardly peels off on the joined boundary face even where a polyamide resin-molded gear core is joined to a polyamide resin-molded gear tooth, and is excellent in dimensional accuracy.

### DISCLOSURE OF THE INVENTION

In order to solve the above problems, a gear according to Claim 1 is that, wherein a polyamide resin-made gear tooth is joined in an integrated form on the outer circumference of the gear core having at least the circumferential part molded by polyamide resin, the gear core and the gear tooth are joined in an integrated form after a joining auxiliary agent including phenol compounds as (A) ingredients and organic solvents as (B) ingredients capable of dissolving or dispersing (A) ingredients is coated on the outer circumference of the gear core or on the inner circumference of the gear tooth.

Further, a gear according to Claim 2 is that, wherein the phenol compounds are at least one type of compounds selected from dihydroxybenzene, dihydroxybenzoic acid, trihydroxybenzene and trihydroxybenzoic acid.

A gear according to Claim 3 is that, wherein the content of (A) ingredients is from 1% by weight or higher to 50% by weight or lower and the content of (B) ingredients is from 50% by weight or higher to 99% by weight or lower.

A gear according to Claim 4 is that, wherein (B) ingredients are mixed organic solvents consisting of several types of organic solvents.

Further, a gear according to Claim 5 is that, wherein the polyamide resin which is used to mold the gear core and/or the gear tooth includes a reinforced fiber.

According to the gear of the present invention, the gear core and the gear tooth which are separated are joined in an integrated form and can be controlled more effectively for an adverse effect of mold shrinkage to obtain a higher dimensional accuracy than conventional polyamide resin gears which are molded in an integrated form from the beginning.

In addition, the above-described gear is coated on the outer circumference of the gear core or the inner circumference of the gear tooth with a joining auxiliary agent containing specific ingredients, by which the polyamide resin on the outer circumference of the gear core or on the inner circumference of gear tooth undergoes only a slight surface modification due the joining auxiliary agent and then the gear core and then the gear tooth are joined in an integrated form.

As explained above, the gear core and the gear tooth are joined at a higher strength than a case where they are joined together by a conventional method. Thus, where the above-described gear is used at a position to which a great rotational torque is given, for example, a gear for an automobile, it hardly peels off on the joined boundary face and excellent in durability and reliability.

In this instance, better effects are obtained where the phenol compounds are at least one type of compounds selected from dihydroxybenzene, dihydroxybenzoic acid, trihydroxybenzene and trihydroxybenzoic acid, and where the content of (A) ingredients in the joining auxiliary agent is from 1% by weight or higher to 50% by weight or lower and that of (B) ingredients is from 50% by weight or higher to 99% by weight or lower.

Further, a case where a mixed organic solvent in which plural types of organic solvents capable of dissolving or dispersing (A) ingredients are used as (B) ingredients of the joining auxiliary agent is easier in controlling the drying time by evaporation of the joining auxiliary agent and better in the coating property of the joining auxiliary agent than a case where one type of an organic solvent is used.

Therefore, the joining auxiliary agent can be uniformly coated on the outer circumference of the gear core or on the inner circumference of the gear tooth, and the polyamide resin undergoes a uniform surface modification. Thus, the gear excellent in joining reliability can be obtained.

In addition, where a polyamide resin which is used to mold the gear core and/or gear tooth contains a reinforced fiber, an increased rigidity can be imparted to the gear.

### BRIEF DESCRIPTION OF THE DRAWINGS

FIG. 1 is a plan view showing a gear consistent with one embodiment of the present invention;

FIG. 2 is a plan view showing a gear consistent with another embodiment of the present invention;

FIGS. 3A and 3B are external perspective views showing a test piece and a primary mold part for constituting the same;

FIG. 4 is an external perspective view showing a mold used in preparing the test piece by injection molding; and

FIG. 5 is a view for illustrating an aspect of indentation hardness test.

### BEST MODE FOR CARRYING OUT THE INVENTION

Hereinafter, a detailed explanation will be made for the gear related to embodiments of the present invention (hereinafter, sometimes referred to as “present gear”).

### 1. Brief Constitution of the Present Gear

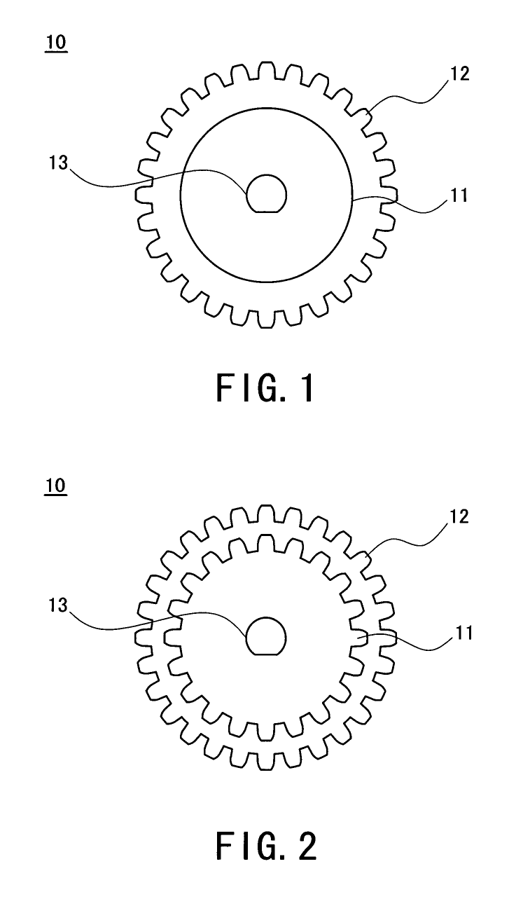

FIG. 1 shows a plain view of the present gear. In the present gear 10, the gear tooth 12 is joined to the outer circumference of the gear core 11 in an integrated form, and the gear core 11 and the gear tooth 12 are joined in an integrated form after a joining auxiliary agent containing specific ingredients is coated on the outer circumference of the gear core 11 or on the inner circumference 11 of the gear tooth 12. Hereinafter, a detailed explanation will be made for the constitution of the present gear 10.

### 2. Detailed Constitution of the Present Gear

### 2.1 Gear Core

In the present gear 10, the gear core 11 is provided at least with the circumferential part molded with a polyamide resin. To be more specific, if the gear core 11 is provided at least with the circumferential part molded with a polyamide resin, the inner circumferential part may be molded with a material other than a polyamide resin, for example, metal. Needless to mention, the gear may be entirely molded with a polyamide resin.

Polyamide resins to be used may include, for example, aliphatic polyamides and aromatic polyamides such as nylon 6, nylon 66, nylon MX6, nylon 11, nylon 12, nylon 46, nylon 610, nylon 612, and one or two types of them may be mixed. A polymer alloy resin which contains these polyamide resins may be also acceptable.

A reinforced fiber may be added at an appropriate percentage to the polyamide resin, with the rigidity given to the gear 10 taken into account. Reinforced fibers include, for example, carbon fiber, glass fiber, silicon carbide fiber and alumina fiber, and one or two types of them may be mixed.

Further, the polyamide resin may contain various additives such as filling agent, pigment, stabilizing agent, smoothing agent, fire-retardant, antioxidant and softener, whenever necessary, in addition to reinforced fiber.

As shown in FIG. 1, the gear core 11 has an axial aperture 13 around the center, into which an axial member (not illustrated) can be fitted. The axial aperture 13 may be eccentric.

The circumferential part of the gear core 11 is a circular shape, as illustrated in FIG. 1, but may be a circular shape having an irregularity, as illustrated in FIG. 2. Further, the circumferential part of the gear core 11 shall not be restricted to the circular shape but may be a triangular shape, a rectangular shape and a polygonal shape or those having an irregularity.

### 2.2. Gear Tooth

In the present gear 10, the gear tooth 12 is molded with a polyamide resin and joined to the outer circumference of the gear core 11 in an integrated form.

A polyamide resin which is the same as that used in the above explained gear core 11 may be used as a polyamide resin used in making the gear tooth 12, and therefore an explanation will be omitted. Such polyamide resin may contain a reinforced fiber at an appropriate ratio, with the friction of the other gear taken into account. Further, the above-explained various additives may be added, whenever necessary.

As to the gear tooth 12, dimensions such as number of gear tooth, face width, width of tooth space, total tooth depth and pitch circle shall not be restricted in particular but may be established appropriately depending on a site at which the present gear 10 is used.

### 2.3. Joining Auxiliary Agent

In the present gear 10, the gear core 11 and the gear tooth 12 are joined in an integrated form after a joining auxiliary agent containing specific ingredients is coated on the outer circumference of the gear core 11 or on the inner circumference of the gear tooth 12.

In this instance, the joining auxiliary agent contains phenol compounds as (A) ingredients and organic solvents as (B) ingredients capable of dissolving or dispersing (A) ingredients.

It is preferable that phenol compounds as (A) ingredients are at least one type of compounds selected from dihydroxybenzene, dihydroxybenzoic acid, trihydroxybenzene and trihydroxybenzoic acid, because these compounds are superior in effectively giving surface modification to a polyamide resin.

To be specific, dihydroxybenzenes include 1,2 dihydroxybenzene (CAS No.: RN [120-80-9]), 1,3 dihydroxybenzene (CAS No.: RN [108-46-3]) and 1,4 dihydroxybenzene (CAS No.: RN [123-31-9]).

Further, dihydroxybenzoic acids include 2,3 dihydroxybenzoic acid (CAS No.: RN [303-38-8]), 2,4 dihydroxybenzoic acid (CAS No.: RN [89-86-1]), 2,5 dihydroxybenzoic acid (CAS No.: RN [490-79-9]), 2,6 dihydroxybenzoic acid (CAS No.: RN [303-07-1]), 3,4 dihydroxybenzoic acid (CAS No.: RN [99-50-3]) and 3,5 dihydroxybenzoic acid (CAS No.: RN [99-10-5]).

Furthermore, trihydroxybenzenes include 1,2,3 trihydroxybenzene (CAS No.: RN [87-66-1] pyrogallol), 1,2,4 trihydroxybenzene (CAS No.: RN [533-73-3]), 1,3,5 trihydroxybenzene (CAS No.: RN [108-73-6]) and 1,3,5 trihydroxybenzene dihydrate (CAS No.: RN [6099-90-7]).

In addition, trihydroxybenzoic acids include 2,3,4 trihydroxybenzoic acid (CAS No.: RN [610-02-6]), 2,4,6 trihydroxybenzoic acid (CAS No.: RN [83-30-79]), 2,4,6 trihydroxybenzoic acid monohydrate (CAS No.: RN [71989-93-0]), 3,4,5 trihydroxybenzoic acid (CAS No.: RN [149-91-7], gallic acid) and 3,4,5 trihydroxybenzoic acid monohydrate (CAS No.: RN [5995-86-8]).

One type or two or more types of these compounds may be selected from similar compounds which have relationship with a position isomer.

Further, these compounds may be used singularly or in combination. Specific combinations include dihydroxybenzene and dihydroxybenzoic acid, trihydroxybenzene and trihydroxybenzoic acid, trihydroxybenzene and/or trihydroxybenzoic acid and dihydroxybenzene and/or dihydroxybenzoic acid.

A more preferable combination is that which contains at least either or both of trihydroxybenzene and trihydroxybenzoic acid. Where these compounds are contained, a polyamide resin is given a particularly excellent surface modification, peeling takes pace less frequently on a joined boundary face between the gear core 11 and the gear tooth 12, thereby providing a gear excellent in durability and reliability.

Organic solvents as (B) ingredients may be volatile or non-volatile as far as they are capable of dissolving or dispersing (A) ingredients. Preferable is a volatile organic solvent. An organic solvent capable of dissolving a polyamide resin to an extremely slight extent may be also desirably used.

To be specific, organic solvents include alcohols having the carbon number of 1 to 6, ketones and aldehydes having the carbon number of 1 to 6, and nitrites having the carbon number of 1 to 6. To be more specific, they include methanol, ethanol, isopropyl alcohol, acetone, acetonitrile, and one type or two or more types of them may be mixed.

Where plural organic solvents are mixed and used as a mixed organic solvent, the drying time can be adjusted appropriately so that a joining auxiliary agent will not be dried immediately after coating on the outer circumference of the gear core 11 or on the inner circumference of the gear tooth 12, with consideration given to the temperature conditions and the working environment in using the joining auxiliary agent.

In the joining auxiliary agent, it is desirable that (A) ingredients and (B) ingredients should be contained respectively in the range from 1% by weight or higher to 50% by weight or lower and in the range from 50% by weight or higher to 99% by weight or lower, in view of preventing possible peeling at the joined boundary face between the gear core 11 and the gear tooth 12.

It is preferable that (A) ingredients are contained in the range from 5% by weight or higher to 30% by weight or lower and (B) ingredients are in the range from 70% by weight or higher to 95% by weight or lower, and it is more preferable that (A) ingredients are in the range from 5% by weight or higher to 15% by weight or lower and (B) ingredients are in the range from 85% by weight or higher to 95% by weight or lower.

Where (A) ingredients exceed 50% by weight and (B) ingredients are lower than 50% by weight, it may be difficult to dissolve or disperse (A) ingredients into (B) ingredients. In contrast, where (A) ingredients are lower than 1% by weight and (B) ingredients exceeds 99% by weight, the joining strength between the gear core 11 and the gear tooth 12 may be decreased.

The above-described polyamide resin, dye, thickener and antioxidant may be added to the joining auxiliary agent, in addition to (A) ingredients and (B) ingredients, in a quantity not to affect the surface modification of the polyamide resin.

Addition of a polyamide resin, for example, can increase joining reliability, the reason of which may be due to the fact that thus-added polyamide resin will decrease the irregularity on the outer circumference of the gear core 11 or on the inner circumference of the gear tooth 12 and will increase the contacting area.

In this instance, it is desirable that the polyamide resin to be added is a polyamide resin similar to that used in the gear core 11 and the gear tooth 12.

Further, addition of a dye, for example, makes it possible to visually confirm the coating condition on the outer circumference of the gear core 11 or on the inner circumference of the gear tooth 12. Therefore, it is possible to improve the coating work and also reduce the coating unevenness.

Furthermore, addition of a thickener, for example, is advantageous in preventing drip of ingredients and providing a uniform coating when the joining auxiliary agent is coated.

The joining auxiliary agent may be prepared by any method, as far as it can dissolve or disperse (A) ingredients in (B) ingredients uniformly. For example, there is a method by which (A) ingredients and (B) ingredients are formulated so as to give a predetermined percentage by weight and mixed well by using an agitator.

### 2.4 Type of the Present Gear

In the above embodiment, an explanation was made by referring to the drawing of the spur gear. The present gear 10 shall not be restricted to a spur gear but may include various types of gears such as helical gear, double helical gear, spiral wheel, worm gear and chain wheel.

### 3. Method for Manufacturing the Present Gear

Then, an explanation will be made about a method for manufacturing the present gear. Where the gear core and the gear tooth of the present gear are molded with a polyamide resin (including that to which additives such as a reinforced fiber are added, the same shall apply hereinafter), for example, there is a desirable method for preparing the present gear by conducting injection molding at least two times.

To be specific, there is a method for manufacturing the gear comprising a gear core-molding step of molding the gear core with a polyamide resin by injection molding and a gear tooth-molding step of molding the gear tooth with a polyamide resin by injection molding, wherein in either of these steps, the above-described joining auxiliary agent is coated on the outer circumference of the gear core or on the inner circumference of the gear tooth molded by the other step and the resultant is placed into a mold and subjected to injection molding.

In this instance, any coating method may be employed, as far as the joining auxiliary agent can be coated on the outer circumference of the gear core or on the inner circumference of the gear tooth quantitatively and in a thinly spread manner. Specific coating methods include brush coating and sponge coating.

It is preferable that the gear core-molding step is carried out before the gear tooth-molding step. The gear core which accounts for a substantial dimension of the gear has been already shrunken and solidified by the previous injection molding, and the gear tooth, a remaining part of the gear is injected on the outer circumference of the gear core. Therefore, the gear core will hardly shrink, and dimensional accuracy is dependent on the shrinkage of the gear tooth which is smaller than that of the gear core, thereby easily providing a gear higher in dimensional accuracy.

Where a gear core and a gear tooth are made with a polyamide resin, the gear core may be molded by extrusion molding, compression molding and cutting work, in addition to injection molding. In this instance, the gear tooth may be subjected to injection molding after a joining auxiliary agent is coated on the outer circumference of the gear core molded by extrusion molding and others.

Further, where the circumferential part of the gear core is molded at least with a polyamide resin, for example, where the inner circumferential part is molded with a metal and the circumferential part is molded with a polyamide resin, insert molding process may be used to fix the polyamide resin on the outer circumference of a metal core, and the joining auxiliary agent is coated on the outer circumference of thus-obtained gear core, which is then placed into a mold to inject a gear tooth.

In the above described method for manufacturing the present gear, a gear tooth molded by injection molding all at once is advantageous in terms of the number of manufacturing steps and manufacturing cost. Where dimensional accuracy is required in particular, teeth may be cut and finished after injection molding. Needless to mention, the gear tooth may be molded by giving a rough configuration on injection molding and then conducting the teeth cutting work.

### 4. Action of the Present Gear

According to the present gear, the gear core and the gear tooth which are separated are joined in an integrated form and can be controlled more effectively for an adverse effect of mold shrinkage to obtain a higher dimensional accuracy than conventional polyamide resin gears which are molded in an integrated form from the beginning.

In addition, the present gear is coated on the outer circumference of the gear core or the inner circumference of gear tooth by using a joining auxiliary agent containing specific ingredients, by which the polyamide resin on the outer circumference of the gear core or on the inner circumference of gear tooth undergoes only a slight surface modification due the joining auxiliary agent and then they are joined in an integrated form.

Therefore, the gear core and the gear tooth are joined at a higher strength than a case where they are joined together by a conventional method. Thus, where the present gear is used at a position to which a great rotational torque is given, for example, a gear for an automobile, it hardly peels off at the joined boundary face and excellent in durability and reliability.

It is assumed that the present gear may provide the above-described action for the following reason. In the present gear, when the joining auxiliary agent is coated on the outer circumference of the gear core or on the inner circumference of the gear tooth, (A) ingredients cause reduction, by which a polyamide resin on the outer circumference of the gear core or the inner circumference of the gear tooth is subjected to surface modification and activated chemically. Then, when the polyamide resin is injected to thus-activated surface and fused thereon, the gear core and the gear tooth are firmly joined and integrated through chemical bonding during recrystallization of the polyamide resin which is in a state of fusion.

Therefore, according to the present gear, it is assumed that a firm joined boundary face may be provided even where a polyamide resin is used which is narrow in melting-point range and very short in curing time. Thus, where the present gear is used at a position to which a great rotational torque is given, it hardly peels off at the joined boundary face and excellent in durability and reliability.

### EXAMPLE

Hereinafter, a specific explanation will be made for the present invention with reference to examples. In the following examples, the same symbol is given to the member having the same function with that described in the above embodiments.

### 1. Preparation of Joining Auxiliary Agents Used for the Gear of the Present Example

In the first place, joining auxiliary agents used for the gear of the present example were prepared according to the following procedures. Namely, as shown in Table 1 through Table 12 to be described later, (A) ingredients such as 1,2,3 trihydroxybenzene(pyrogallol), 3,4,5 trihydroxybenzoic acid (gallic acid), 1,3 dihydroxybenzene and 3,5 dihydroxybenzoic acid and (B) ingredients such as methanol and isopropyl alcohol were formulated so as to give a predetermined percentage by weight and mixed well by using a stirrer to obtain joining auxiliary agents No. 1 through 78 used for the gear of the present example.

In the table, the joining auxiliary agents No. 40 through 78 are the same in formulation as the joining auxiliary agents No. 1 through 39. Further, 1,2,3 trihydroxybenzene, 3,4,5 trihydroxybenzoic acid, 1,3 dihydroxybenzene, 3,5 dihydroxybenzoic acid, methanol, isopropyl alcohol were all made by Wako Pure Chemical Industries Ltd.

### 2. Evaluation of Joining Strength by Tensile Test

In order to briefly understanding the performance of various joining auxiliary agents prepared as above, at a prior stage of manufacturing the gear, test pieces shaped into paper strips to which these joining auxiliary agent were added were prepared to conduct a tensile test. A detailed explanation will be made as follows.

### 2.1. Preparation of Test Pieces to be Used in Tensile Test

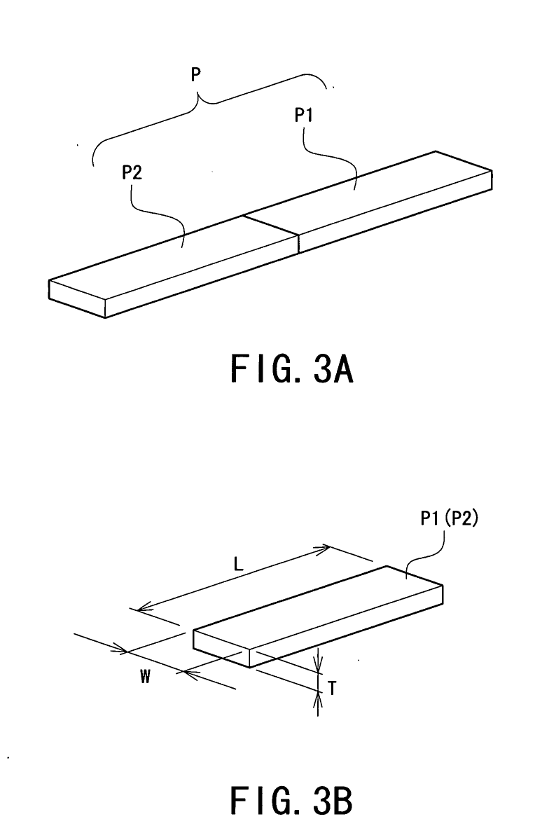

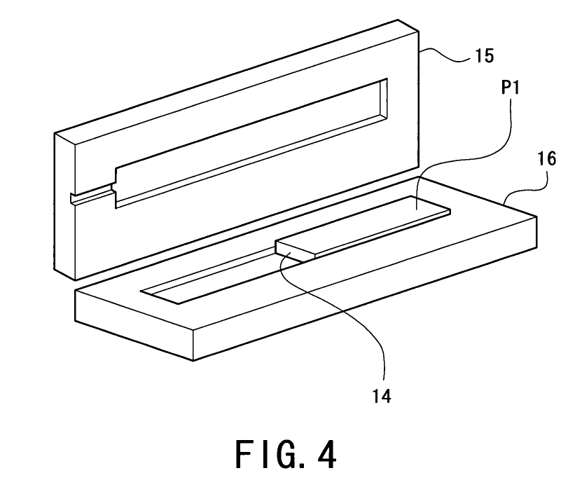

FIGS. 3A and 3B are external perspective views of the test piece and the primary mold part for constituting the same. FIG. 4 is an external perspective view of the mold used in preparing the test piece by injection molding.

Injection molding was employed to mold test pieces P with a polyamide resin by the following procedures. Namely, a primary mold part P1 was molded with a polyamide resin by injection molding, the joining auxiliary agent prepared as above was uniformly coated on the joined edge 14 of the primary mold part by using a brush, then, the resultant was set into the molds 15 and 16, and the polyamide resin, which was the same as that used in the primary mold part P1 was injected to provide an additional mold P2. Thus, the test piece P was made, in which the primary mold part P1 and the additional mold P2 were joined in an integrated form.

In this instance, the test piece P was shaped into a paper strip and uniform in thickness. The primary mold part P1 and the additional mold P2 were the same in dimension (40 mm in length×10 mm in width×3 mm in thickness), and the test piece in which they were joined in an integrated form was 80 mm in entire length.

The test pieces P were molded with nylon 6 resin (“Amiran CM 1026”, Toray Industries Inc.) and nylon 66 resin (“Xitel 101L”, Du Pont Kabushiki Kaisha).

Further, the injection molding was done by using an injection molding machine (“SE-18S”, Sumitomo Heavy Industries Ltd.) at molding temperatures of 240, 245, 240 and 235° C. for nylon 6 resin in the order from the injection nozzle and at 290, 295, 290 and 285° C. for nylon 66 in the order from the injection nozzle.

The tool temperature of the primary mold part P1 was set at 65° C. both for nylon 6 and nylon 66, and that of the additional mold P2 was set at 95° C.

### 2.2. Tensile Test

The above-prepared test pieces No. 1 through 78 were used to run a tensile test at a room kept at temperature of 23° C. and humidity of 50% (number of samples: n=5), by which a maximum tensile strength until breakage was determined for each test piece. In this instance, the test was conducted at 5 mm/minute by using a universal material tester (INSTRON 4505).

### 2.3. Formulation of Joining Auxiliary Agent and Results of Tensile Test

Tables 1 through 12 show the results of the tensile test for these test pieces, together with the formulation of the joining auxiliary agents used in the test. The test pieces No. 1 through 39 were molded with nylon 6 resin and No. 40 through 78 were molded with nylon 66 resin.

TABLE 1

| | | No. 1 | No. 2 | No. 3 | No. 4 | No. 5 | No. 6 | No. 7 |
|---|---|---|---|---|---|---|---|---|
| 1,2,3 trihydroxybenzene | (% by weight) | 4.0 | 8.0 | 12.0 | 16.0 | 20.0 | 24.0 | 28.0 |
| 3,4,5 trihydroxybenzoic acid | (% by weight) | | | | | | | |
| 1,3 dihydroxybenzene | (% by weight) | | | | | | | |
| 3,5 dihydroxybenzoic acid | (% by weight) | | | | | | | |
| Methanol | (% by weight) | 48.0 | 46.0 | 44.0 | 42.0 | 40.0 | 38.0 | 36.0 |
| Isopropyl alcohol | (% by weight) | 48.0 | 46.0 | 44.0 | 42.0 | 40.0 | 38.0 | 36.0 |
| Tensile strength | (MPa) | 46.5 | 49.4 | 58.5 | 60.8 | 54.3 | 48.2 | 44.6 |
| Standard deviation | (MPa) | 5.9 | 8.2 | 9.3 | 9.1 | 7.4 | 4.4 | 6.8 |

TABLE 2

| | | No. 8 | No. 9 | No. 10 | No. 11 | No. 12 | No. 13 | No. 14 |
|---|---|---|---|---|---|---|---|---|
| 1,2,3 trihydroxybenzene | (% by weight) | | | | | | | |
| 3,4,5 trihydroxybenzoic acid | (% by weight) | 4.0 | 8.0 | 12.0 | 16.0 | 20.0 | 24.0 | 28.0 |
| 1,3 dihydroxybenzene | (% by weight) | | | | | | | |
| 3,5 dihydroxybenzoic acid | (% by weight) | | | | | | | |
| Methanol | (% by weight) | 48.0 | 46.0 | 44.0 | 42.0 | 40.0 | 38.0 | 36.0 |
| Isopropyl alcohol | (% by weight) | 48.0 | 46.0 | 44.0 | 42.0 | 40.0 | 38.0 | 36.0 |
| Tensile strength | (MPa) | 53.2 | 51.9 | 56.5 | 58.3 | 61.2 | 53.8 | 56.2 |
| Standard deviation | (MPa) | 8.3 | 5.9 | 7.2 | 6.1 | 5.5 | 6.8 | 4.5 |

TABLE 3

| | | No. 15 | No. 16 | No. 17 | No. 18 | No. 19 | No. 20 | No. 21 |
|---|---|---|---|---|---|---|---|---|
| 1,2,3 trihydroxybenzene | (% by weight) | | | | | | | |
| 3,4,5 trihydroxybenzoic acid | (% by weight) | | | | | | | |
| 1,3 dihydroxybenzene | (% by weight) | 4.0 | 8.0 | 12.0 | 16.0 | 20.0 | 24.0 | 28.0 |
| 3,5 dihydroxybenzoic acid | (% by weight) | | | | | | | |
| Methanol | (% by weight) | 48.0 | 46.0 | 44.0 | 42.0 | 40.0 | 38.0 | 36.0 |
| Isopropyl alcohol | (% by weight) | 48.0 | 46.0 | 44.0 | 42.0 | 40.0 | 38.0 | 36.0 |
| Tensile strength | (MPa) | 49.6 | 52.1 | 55.5 | 53.4 | 59.3 | 57.6 | 59.9 |
| Standard deviation | (MPa) | 6.4 | 8.2 | 4.3 | 6.2 | 9.3 | 8.5 | 6.7 |

TABLE 4

| | | No. 22 | No. 23 | No. 24 | No. 25 | No. 26 | No. 27 | No. 28 |
|---|---|---|---|---|---|---|---|---|
| 1,2,3 trihydroxybenzene | (% by weight) | | | | | | | |
| 3,4,5 trihydroxybenzoic acid | (% by weight) | | | | | | | |
| 1,3 dihydroxybenzene | (% by weight) | | | | | | | |
| 3,5 dihydroxybenzoic acid | (% by weight) | 4.0 | 8.0 | 12.0 | 16.0 | 20.0 | 24.0 | 28.0 |
| Methanol | (% by weight) | 48.0 | 46.0 | 44.0 | 42.0 | 40.0 | 38.0 | 36.0 |
| Isopropyl alcohol | (% by weight) | 48.0 | 46.0 | 44.0 | 42.0 | 40.0 | 38.0 | 36.0 |
| Tensile strength | (MPa) | 51.2 | 49.3 | 53.5 | 56.9 | 60.1 | 53.2 | 55.6 |
| Standard deviation | (MPa) | 8.3 | 6.4 | 5.6 | 3.5 | 2.5 | 8.9 | 6.7 |

TABLE 5

| | | No. 29 | No. 30 | No. 31 | No. 32 | No. 33 | No. 34 | No. 35 |
|---|---|---|---|---|---|---|---|---|
| 1,2,3 trihydroxybenzene | (% by weight) | 4.0 | 8.0 | 16.0 | 6.0 | 8.0 | 6.0 | 4.0 |
| 3,4,5 trihydroxybenzoic acid | (% by weight) | 4.0 | | | 6.0 | | 6.0 | 4.0 |
| 1,3 dihydroxybenzene | (% by weight) | | 4.0 | | 4.0 | 4.0 | | 4.0 |
| 3,5 dihydroxybenzoic acid | (% by weight) | | | 8.0 | | 4.0 | 4.0 | 4.0 |
| Methanol | (% by weight) | 46.0 | 44.0 | 38.0 | 42.0 | 42.0 | 42.0 | 42.0 |
| Isopropyl alcohol | (% by weight) | 46.0 | 44.0 | 38.0 | 42.0 | 42.0 | 42.0 | 42.0 |
| Tensile strength | (MPa) | 49.3 | 57.1 | 65.7 | 62.1 | 66.9 | 69.8 | 64.6 |
| Standard deviation | (MPa) | 6.5 | 6.2 | 7.3 | 15.1 | 8.2 | 6.9 | 4.2 |

TABLE 6

| | | No. 36 | No. 37 | No. 38 | No. 39 |
|---|---|---|---|---|---|
| 1,2,3 trihydroxybenzene | (% by weight) | | | | |
| 3,4,5 trihydroxybenzoic acid | (% by weight) | 8.0 | 8.0 | 8.0 | |
| 1,3 dihydroxybenzene | (% by weight) | 4.0 | | 4.0 | 8.0 |
| 3,5 dihydroxybenzoic acid | (% by weight) | | 4.0 | 4.0 | 8.0 |
| Methanol | (% by weight) | 44.0 | 44.0 | 42.0 | 42.0 |
| Isopropyl alcohol | (% by weight) | 44.0 | 44.0 | 42.0 | 42.0 |
| Tensile strength | (MPa) | 63.0 | 59.5 | 60.1 | 64.1 |
| Standard deviation | (MPa) | 7.1 | 10.2 | 9.3 | 6.8 |

TABLE 7

| | | No. 40 | No. 41 | No. 42 | No. 43 | No. 44 | No. 45 | No. 46 |
|---|---|---|---|---|---|---|---|---|
| 1,2,3 trihydroxybenzene | (% by weight) | 4.0 | 8.0 | 12.0 | 16.0 | 20.0 | 24.0 | 28.0 |
| 3,4,5 trihydroxybenzoic acid | (% by weight) | | | | | | | |
| 1,3 dihydroxybenzene | (% by weight) | | | | | | | |
| 3,5 dihydroxybenzoic acid | (% by weight) | | | | | | | |
| Methanol | (% by weight) | 48.0 | 46.0 | 44.0 | 42.0 | 40.0 | 38.0 | 36.0 |
| Isopropyl alcohol | (% by weight) | 48.0 | 46.0 | 44.0 | 42.0 | 40.0 | 38.0 | 36.0 |
| Tensile strength | (MPa) | 52.6 | 70.9 | 72.3 | 68.5 | 63.2 | 59.8 | 58.2 |
| Standard deviation | (MPa) | 5.8 | 9.1 | 4.5 | 6.3 | 3.9 | 10.6 | 11.2 |

TABLE 8

| | | No. 47 | No. 48 | No. 49 | No. 50 | No. 51 | No. 52 | No. 53 |
|---|---|---|---|---|---|---|---|---|
| 1,2,3 trihydroxybenzene | (% by weight) | | | | | | | |
| 3,4,5 trihydroxybenzoic acid | (% by weight) | 4.0 | 8.0 | 12.0 | 16.0 | 20.0 | 24.0 | 28.0 |
| 1,3 dihydroxybenzene | (% by weight) | | | | | | | |
| 3,5 dihydroxybenzoic acid | (% by weight) | | | | | | | |
| Methanol | (% by weight) | 48.0 | 46.0 | 44.0 | 42.0 | 40.0 | 38.0 | 36.0 |
| Isopropyl alcohol | (% by weight) | 48.0 | 46.0 | 44.0 | 42.0 | 40.0 | 38.0 | 36.0 |
| Tensile strength | (MPa) | 62.3 | 60.4 | 58.4 | 66.9 | 59.0 | 61.3 | 64.5 |
| Standard deviation | (MPa) | 5.0 | 5.8 | 9.2 | 8.9 | 9.9 | 9.5 | 10.5 |

TABLE 9

| | | No. 54 | No. 55 | No. 56 | No. 57 | No. 58 | No. 59 | No. 60 |
|---|---|---|---|---|---|---|---|---|
| 1,2,3 trihydroxybenzene | (% by weight) | | | | | | | |
| 3,4,5 trihydroxybenzoic acid | (% by weight) | | | | | | | |
| 1,3 dihydroxybenzene | (% by weight) | 4.0 | 8.0 | 12.0 | 16.0 | 20.0 | 24.0 | 28.0 |
| 3,5 dihydroxybenzoic acid | (% by weight) | | | | | | | |
| Methanol | (% by weight) | 48.0 | 46.0 | 44.0 | 42.0 | 40.0 | 38.0 | 36.0 |
| Isopropyl alcohol | (% by weight) | 48.0 | 46.0 | 44.0 | 42.0 | 40.0 | 38.0 | 36.0 |
| Tensile strength | (MPa) | 57.3 | 56.9 | 59.4 | 55.1 | 60.1 | 56.2 | 57.9 |
| Standard deviation | (MPa) | 8.0 | 6.9 | 8.8 | 10.3 | 11.4 | 7.7 | 9.4 |

TABLE 10

| | | No. 61 | No. 62 | No. 63 | No. 64 | No. 65 | No. 66 | No. 67 |
|---|---|---|---|---|---|---|---|---|
| 1,2,3 trihydroxybenzene | (% by weight) | | | | | | | |
| 3,4,5 trihydroxybenzoic acid | (% by weight) | | | | | | | |
| 1,3 dihydroxybenzene | (% by weight) | | | | | | | |
| 3,5 dihydroxybenzoic acid | (% by weight) | 4.0 | 8.0 | 12.0 | 16.0 | 20.0 | 24.0 | 28.0 |
| Methanol | (% by weight) | 48.0 | 46.0 | 44.0 | 42.0 | 40.0 | 38.0 | 36.0 |
| Isopropyl alcohol | (% by weight) | 48.0 | 46.0 | 44.0 | 42.0 | 40.0 | 38.0 | 36.0 |
| Tensile strength | (MPa) | 54.5 | 58.4 | 59.3 | 56.9 | 57.2 | 59.2 | 57.1 |
| Standard deviation | (MPa) | 6.6 | 6.9 | 8.3 | 10.1 | 9.6 | 8.8 | 11.2 |

TABLE 11

| | | No. 68 | No. 69 | No. 70 | No. 71 | No. 72 | No. 73 | No. 74 |
|---|---|---|---|---|---|---|---|---|
| 1,2,3 trihydroxybenzene | (% by weight) | 4.0 | 8.0 | 16.0 | 6.0 | 8.0 | 6.0 | 4.0 |
| 3,4,5 trihydroxybenzoic acid | (% by weight) | 4.0 | | | 6.0 | | 6.0 | 4.0 |
| 1,3 dihydroxybenzene | (% by weight) | | 4.0 | | 4.0 | 4.0 | | 4.0 |
| 3,5 dihydroxybenzoic acid | (% by weight) | | | 8.0 | | 4.0 | 4.0 | 4.0 |
| Methanol | (% by weight) | 46.0 | 44.0 | 38.0 | 42.0 | 42.0 | 42.0 | 42.0 |
| Isopropyl alcohol | (% by weight) | 46.0 | 44.0 | 38.0 | 42.0 | 42.0 | 42.0 | 42.0 |
| Tensile strength | (MPa) | 66.2 | 64.5 | 58.7 | 69.5 | 70.8 | 72.6 | 66.3 |
| Standard deviation | (MPa) | 5.6 | 7.3 | 6.1 | 10.5 | 8.2 | 5.4 | 9.6 |

TABLE 12

| | | No. 75 | No. 76 | No. 77 | No. 78 |
|---|---|---|---|---|---|
| 1,2,3 trihydroxybenzene | (% by weight) | | | | |
| 3,4,5 trihydroxybenzoic acid | (% by weight) | 8.0 | 8.0 | 8.0 | |
| 1,3 dihydroxybenzene | (% by weight) | 4.0 | | 4.0 | 8.0 |
| 3,5 dihydroxybenzoic acid | (% by weight) | | 4.0 | 4.0 | 8.0 |
| Methanol | (% by weight) | 44.0 | 44.0 | 42.0 | 42.0 |
| Isopropyl alcohol | (% by weight) | 44.0 | 44.0 | 42.0 | 42.0 |
| Tensile strength | (MPa) | 61.1 | 69.9 | 71.9 | 60.5 |
| Standard deviation | (MPa) | 10.3 | 6.3 | 9.9 | 6.8 |

### 2.4. Preparation of Comparative Test Pieces and Results of Tensile Test

(Comparative Test Piece No. 1)

A comparative test piece No. 1 was molded with nylon 6 resin in the same manner as the above-described test pieces Nos. 1 through 39 except that the comparative test piece No. 1 was molded to have entirely the same shape as the test piece P by a one-time injection molding. A tensile strength of the comparative test piece No. 1 was 76.3 MPa and a standard deviation thereof was 0.8 MPa.

(Comparative Test Piece No. 2)

A comparative test piece No. 2 was molded with nylon 6 resin in the same manner as the above-described test pieces Nos. 1 through 39 except that no joining auxiliary agent was coated on a joined edge 14 of a primary mold part P1. A tensile strength of the comparative test piece No. 2 was 13.3 MPa and a standard deviation thereof was 9.2 MPa.

(Comparative Test Piece No. 3)

A comparative test piece No. 3 was molded with nylon 66 resin in the same manner as the above-described test pieces Nos. 40 through 78 except that the comparative test piece No. 3 was molded to have entirely the same shape as the test piece P by a one-time injection molding. A tensile strength of the comparative test piece No. 3 was 78.8 MPa and a standard deviation thereof was 1.8 MPa.

(Comparative Test Piece No. 4)

A comparative test piece No. 4 was molded with nylon 66 resin in the same manner as the above-described test pieces Nos. 40 through 78 except that no joining auxiliary agent was coated on a joined edge 14 of a primary mold part P1. A tensile strength of the comparative test piece No. 4 was 6.1 MPa and a standard deviation thereof was 1.5 MPa.

### 2.5. Discussion About Results of Tensile Test

It can be known that the test pieces Nos. 1 through 39 have joining strengths which bear comparison with the comparative test piece No. 1 which was molded by the one-time injection molding. In addition, it can be known that the test pieces Nos. 1 through 39 have joining strengths far superior to the comparative test piece No. 2 in which the joining was made employing no joining auxiliary agent.

It can be known that the test pieces Nos. 40 through 78 have joining strengths which bear comparison with the comparative test piece No. 3 which was molded by the one-time injection molding. In addition, it can be known that the test pieces Nos. 40 through 78 have joining strengths far superior to the comparative test piece No. 4 in which the joining was made employing no joining auxiliary agent.

It is assumed that when the joining auxiliary agent prepared as above is coated on a surface of the joined edge 14, (A) ingredients cause reduction, by which a polyamide resin on the surface of the joined edge 14 is activated. Then, when an additional mold P2 is injected to the thus-activated joined edge 14 and fused thereon, the both are firmly joined and integrated through chemical bonding during recrystallization of the polyamide resin which is in a state of fusion.

### 3. Preparation of a Gear of the Example

In the next place, a gear 10 was molded to have the shape shown in FIG. 1 with the use of the above-prepared joining auxiliary agent No. 50 according to the following procedures.

To be specific, with nylon 66 resin containing 33% by weight of glass fiber (“Xitel 70G33”, Du Pont Kabushiki Kaisha), a gear core 11 the circumferential part of which is a circular shape was firstly molded by injection molding, and the above-prepared joining auxiliary agent No. 50 was thinly coated uniformly on the outer circumference surface of the thus-prepared gear core 11 by using a brush. Then, the resultant was set into a mold (not illustrated), and a gear tooth 12 was molded with nylon 66 resin (“Xitel 101L”, Du Pont Kabushiki Kaisha) by injecting molding. Thus, the gear 10 was made, in which the gear core 11 and the gear tooth 12 were joined in an integrated form.

In this instance, conditions of the injection molding were set as follows. To be specific, the injection molding was done by using an injection molding machine (“M-20A-SJC”, MEIKI CO., LTD.) (mold clamping forth: 20 t) at molding temperatures of 290, 295, 290 and 285° C. in the order from the injection nozzle. The tool temperatures at the time of manufacturing the gear core 11 and the gear tooth 12 were both set at 85° C.

### 4. Preparation of a Gear of a Comparative Example

A gear of a comparative example was prepared in the same manner as the gear 10 of the above-described example except that no joining auxiliary agent was coated.

### 5. Indentation Strength Test on the Gears of the Example and the Comparative Example

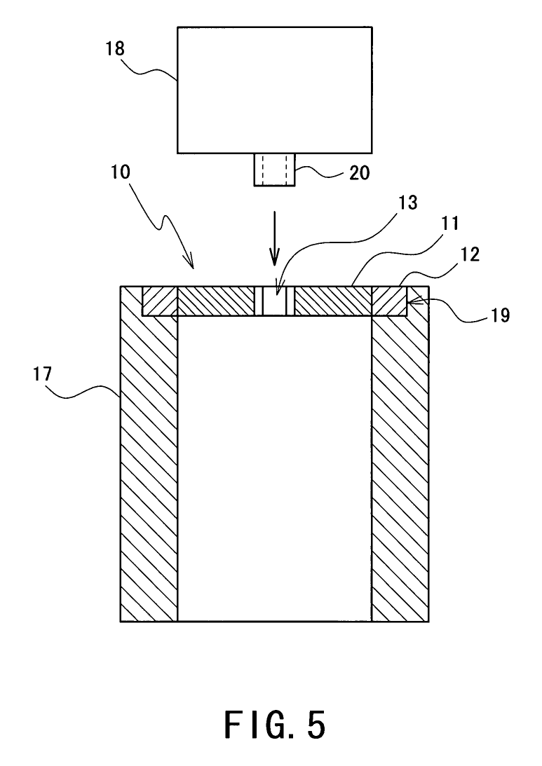

Then, indentation strength tests were conducted on the above-prepared gears of the example and the comparative example. Jigs 17 and 18 as shown in FIG. 5 were prepared first. To be specific, the jig 17 was formed to be approximately tubular and to have the internal diameter the same as or slightly larger than the outside diameter of the gear core 11 of the above-prepared gear 10 of the example. In addition, on an inner surface at one opening end of the heavy-walled jig 17, a concave portion 19 was formed so as to place the gear tooth 12 of the above-prepared gear 10 thereon. The jig 18 was formed to be approximately cylindrical, on one end of which a convex portion 20 was formed so as to fit into an axial aperture 13 of the gear 10.

Next, the above-prepared jigs 17 and 18 were attached to a testing machine (“AUTOGRAPH 50TB”, Shimadzu Corporation), and the gear 10 was placed on the concave portion 19 of the jig 17. Then, the jig 18 was indented in the arrow direction in FIG. 5, and a load at the time of breakdown of the gear core 11 and the gear tooth 12 caused by shearing force was read to measure a strength. In this instance, the indentation speed of the jig 18 was set as 2.5 mm/min.

### 6. Results of Indentation Strength Test

Table 13 shows the results of the above-described test.

TABLE 13

| | Thickness | Joining area | Indentation strength |
|---|---|---|---|
| Gear No. | (mm) | (mm²) | (MPa) |
| 1 | 6.35 | 937 | 23.46 |
| 2 | 6.18 | 912 | 22.78 |
| 3 | 6.38 | 941 | 29.47 |
| Comparative example | 6.45 | 951 | 1.54 |

It was confirmed that the gears (gears Nos. 1 through 3) of the example which were prepared with the use of the joining auxiliary agent have the considerably high indentation strengths in comparison with the gear of the comparative example which was prepared without using the joining auxiliary agent.

In addition, from the results of the tensile test and the indentation strength test, it is considered that a gear which is prepared with the use of another joining auxiliary agent equal in performance to the joining auxiliary agent No. 50 which was used in the indentation strength test has an indentation strength equal to the above-prepared gears.

Therefore, it was confirmed that according to the gear of the present invention, the gear hardly peeled off on the joined boundary face even where the polyamide resin-molded gear core was joined to the polyamide resin-molded gear tooth, and that the gear is higher in dimensional accuracy than the one molded by the one-time injection molding from the beginning.

The foregoing description of the preferred embodiments of the invention has been presented for purposes of illustration and description. It is not intended to be exhaustive or to limit the invention to the precise form disclosed, and modifications and variations are possible in the light of the above teachings or may be acquired from practice of the invention. For example, the gear core can be also molded by extrusion molding or cutting work while the gear core is molded by injection molding in the above-described embodiments.

1. A gear in which a polyamide resin-molded gear tooth is joined in an integrated form on the outer circumference of a gear core having at least the circumferential part molded with a polyamide resin, the gear wherein the gear core and the gear tooth are joined in an integrated form after a joining auxiliary agent including phenol compounds as (A) ingredients and organic solvents as (B) ingredients capable of dissolving or dispersing (A) ingredients is coated on the outer circumference of the gear core or on the inner circumference of the gear tooth.

2. A gear according to claim 1, wherein the phenol compounds are at least one type of compounds selected from dihydroxybenzene, dihydroxybenzoic acid, trihydroxybenzene and trihydroxybenzoic acid.

3. A gear according to claim 1, wherein the content of (A) ingredients is from 1% by weight or higher to 50% by weight or lower and the content of (B) ingredients is from 50% by weight or higher to 99% by weight or lower.

4. A gear according to claim 1, wherein (B) ingredients are mixed organic solvents consisting of several types of organic solvents.

5. A gear according to claim 1, wherein the polyamide resin which is used to mold the gear core and/or the gear tooth includes a reinforced fiber.

6. A gear according to claim 2, wherein the content of (A) ingredients is from 1% by weight or higher to 50% by weight or lower and the content of (B) ingredients is from 50% by weight or higher to 99% by weight or lower.

7. A gear according to claim 2, wherein (B) ingredients are mixed organic solvents consisting of several types of organic solvents.

8. A gear according to claim 3, wherein (B) ingredients are mixed organic solvents consisting of several types of organic solvents.

9. A gear according to claim 2, wherein the polyamide resin which is used to mold the gear core and/or the gear tooth includes a reinforced fiber.

10. A gear according to claim 3, wherein the polyamide resin which is used to mold the gear core and/or the gear tooth includes a reinforced fiber.

11. A gear according to claim 4, wherein the polyamide resin which is used to mold the gear core and/or the gear tooth includes a reinforced fiber.
